(19) United States
(12) Patent Application Publication
(10) Pub. No.: US 2026/0259881 A1
(43) Pub. Date: Sep. 3, 2026

(54) MERGING OF QUERIES INTO A QUERY STRAND

(71) Applicant: International Business Machines Corporation, Armonk, NY (US)

(72) Inventors: Jeffrey Owen KEPHART, Cortlandt Manor, NY (US); Jaydeep SEN, Bangalore (IN)

(21) Appl. No.: 19/069,216

(22) Filed: Mar. 3, 2025

(51) Int. Cl. G06F 16/2455; G06F 16/2452; G06F 16/2453

(52) U.S. Cl. CPC G06F 16/2456; G06F 16/24522; G06F 16/2453

(57) ABSTRACT

In some implementations, a computing device may receive a query. The computing device may determine whether the query is associated with a current query strand that includes a set of one more related queries, of a set of one or more previously-established query strands. The computing device may selectively: merge the query with the current query strand comprising the previously-established query strand to form an updated query strand based at least in part on a determination that the query is associated with the current query strand, wherein the merging is based on one or more attributes, one or more operators, or one or more values associated with the query; or establish a new query strand based at least in part on a determination that the query does not belong to the current query strand.

### BACKGROUND

Natural language querying (NLQ) technologies have been developed to enable users to access information stored in databases and other data stores by typing or speaking natural language commands into a chatbot or related user interface. The text of the query may be converted into a database language, such as structured query language (SQL). A computing device may execute the query to generate a response for presentation to a user. In some instances, a user may provide a follow-up query that is intended to modify the query or the response. The follow-up query may include refining input to add to the query, but may not repeat the query as originally provided to the computing device.

### SUMMARY

In some implementations, a method comprises receiving a query. The method comprises determining whether the query is associated with a current query strand that includes a set of one more related queries, of a set of one or more previously-established query strands. The method further comprises selectively: merging the query with the current query strand comprising the previously-established query strand to form an updated query strand based at least in part on a determination that the query is associated with the current query strand, wherein the merging is based on one or more attributes, one or more operators, or one or more values associated with the query; or establishing a new query strand based at least in part on a determination that the query does not belong to the current query strand.

In some implementations, a computer program product comprises one or more computer readable storage media and program instructions collectively stored on the one or more computer readable storage media. The program instructions comprise program instructions to receive a query and program instructions to identify one or more attributes, one or more operators, or one or more values associated with the query. The program instructions comprise program instructions to determine, based at least in part on the one or more attributes, one or more operators, or one or more values associated with the query, that the query is associated with a current query strand that includes a set of one more related queries. The program instructions further comprise program instructions to merge the one or more values associated with the query with the current query strand to form an updated query strand based at least in part on a determination that the query is associated with the current query strand.

In some implementations, a system comprises one or more devices configured to receive a query. The one or more devices may be configured to determine that the query is associated with a current query strand that includes a set of one more related queries. The one or more devices may be configured to identify one or more clauses of the query that match one or more clauses of the existing query strand. The one or more devices may be further configured to merge one or more values associated with the one or more clauses of the query with the current query strand to form an updated query strand.

### BRIEF DESCRIPTION OF THE DRAWINGS

FIGS. 1A-3B are diagrams of an example implementation described herein.

FIG. 4 is a diagram of an example computing environment in which systems and/or methods described herein may be implemented.

FIG. 5 is a diagram of example components of one or more devices of FIGS. 1-4.

FIGS. 6-8 are flowcharts of example processes associated with for merging of queries into a query strand.

### DETAILED DESCRIPTION

The following detailed description of example implementations refers to the accompanying drawings. The same reference numbers in different drawings may identify the same or similar elements.

Natural language querying (NLQ) technologies may be used to perform a query without a user submitting a query in a database language. In this way, users without knowledge of database language may submit queries to a database (e.g., a private database or a network-connected search engine or database, among other examples) and receive relevant responses. In some examples, a user may submit a natural language query using text input or using a voice input, among other examples. If submitting the query as a voice input, a speech-to-text system may convert an audible input to text for submission to the database or as an operation of execution of the query within the database.

In some NLQ systems, a computing device may receive sequential queries. In some instances, a sequential query may be an iterative query intended to refine a previous query. For example, a first query may provide context and a first parameter associated with a subject. The computing device may provide a first response to the first query. The computing device may receive a second query as a follow-up query that modifies the first parameter or adds a second parameter to the first query. In some examples, the second query may rely on context of the first query to obtain a relevant response. For example, the second query may include a partial sentence or pronouns or may lack antecedent basis when analyzed independently from the first query.

In an example, a first query may include “Show me a list of hospitals in Texas with at least 200 beds.” The first query may be interpreted to search a hospital database for records matching “State=Texas” and “Beds≥200.” A second query may include “Show me hospitals in Houston County.” The second query may be interpreted as adding a condition “County=Houston” to the first query. A third query may include “Show me hospitals that have a helipad.” The second query may be interpreted as adding a condition “Helipad=True” to the first query and second query.

In some NLQ systems, complications may arise when follow-up queries are unclear about associations with a previous query. For example, a computing device may erroneously determine whether a subsequent query is a new query strand (unrelated to a previous query) or is intended to refine a previous query. Specifically, in a cumulative query, clauses may either be added or replaced completely by clauses in a follow-up partial query. Subtleties involving values of the cumulative query and follow-up partial queries may not be considered when they are merged to determine whether to add or replace clauses from the cumulative query.

Each query includes conditions that can be interpreted as a conjunction of a set of clauses, each defined by a single attribute. For example, the computing device is to provide a response that is based at least in part on only records that meet conditions defined by all of the clauses together.

In some NLQ systems, a new partial query is merged with a cumulative query to obtain a new resultant cumulative query according to a set of rules. For example, for each clause in a second query, if the clause does not appear in the cumulative query, add the clause from the second query. If the clause does appear in the cumulative query (e.g., with a different operator or value), replace that the clause from the cumulative query with the clause from the second query.

In another example, a first query may include “Show me a list of hospitals in Texas with at least 200 beds.” The first query may be interpreted to search a hospital database for records matching “State=Texas” and “Beds≥200” as previously described. A second query may include “Show me hospitals with at most 500 beds.” Because a quantity of beds is in the second query and the first query, existing NLQ systems may replace “Beds≥200” with “Beds≤500,” even though an intent of the second query may be to refine the first query to return a list of hospitals in Texas with a range of “200≤Beds≤500.”

In another example, a first query may include “Show me hospitals in Texas with at least 200 beds.” The first query may be interpreted to search a hospital database for records matching “State=Texas” and “Beds≥200,” as previously described. A second query may include “Show me hospitals in the United States with at least 200 beds.” The second query may be interpreted to search a hospital database for records matching “Country=United_States” and “Beds≥200.” Some NLQ systems will add the clause defining a country as the United States to the clauses of the first query, including defining a state as Texas. In this example, the second query does not refine the first query because all hospitals in Texas are also in the United States. From context, it appears that this response does not provide an answer to the intended meaning of the second query to expand a geographical area from the state of Texas to the entire country of The United States of America. The context of the request for hospitals in the United States coming after the request for hospitals in Texas indicates that the user intended to widen the geographical results. However, if the request for hospitals in the United States came before the request for hospitals in Texas, context would indicate that the user intends to narrow the search from the entire United States of America to only the state of Texas.

In some aspects described herein, a computing device in an NLQ system may receive a sequence of queries. The sequence of series may be associated with one or more query strands. A query strand may be defined as a set of queries consisting of an original query followed by a succession of queries that are intended to modify one another successively. The modifications may include adding one or more new clauses, removing one or more existing clauses, or modifying one or more existing clauses (e.g., changing operators or values). Within a query strand, the computing device may produce a new cumulative query (e.g., an updated cumulative query) after receiving a subsequent query. The computing device may form the new cumulative query by merging the subsequent query with a previous cumulative query (a first cumulative query is the first query of the query strand).

In some aspects described herein, the computing device may disentangle query strands from a query sequence. For example, the computing device may identify one or more query strands and determine whether a new query is part of an existing query strand or the computing device is to form a new query strand that begins with the new query. Additionally, or alternatively, the computing device may progressively merge successive queries (e.g., partial queries after a first query of a query strand) to existing query strands to form successive cumulative queries with an improved likelihood of following an intent of a user relative to existing solutions.

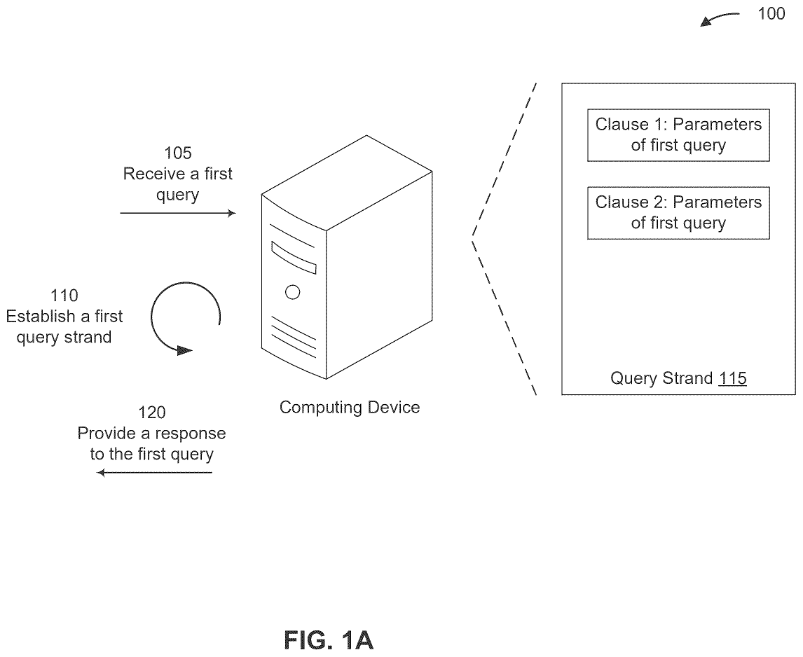

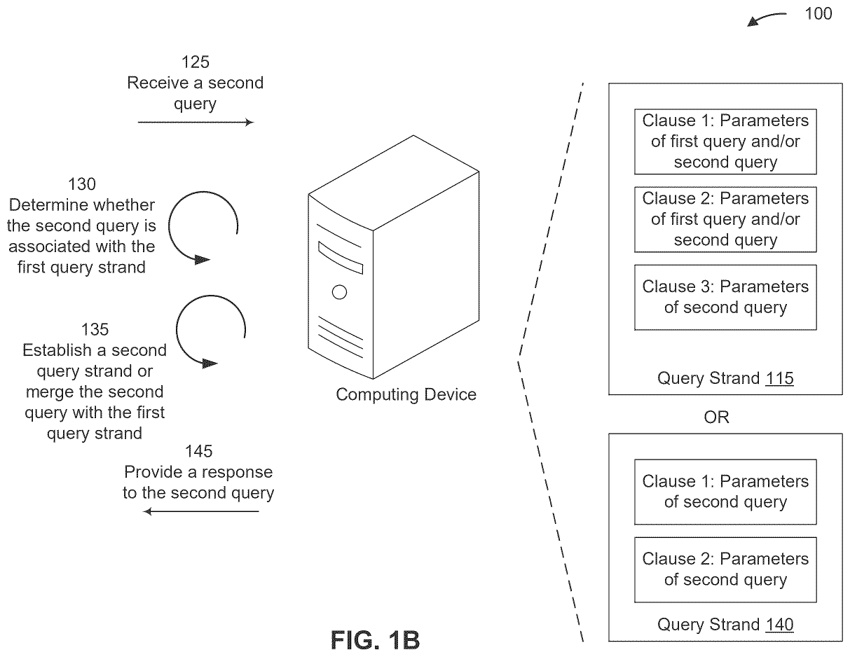

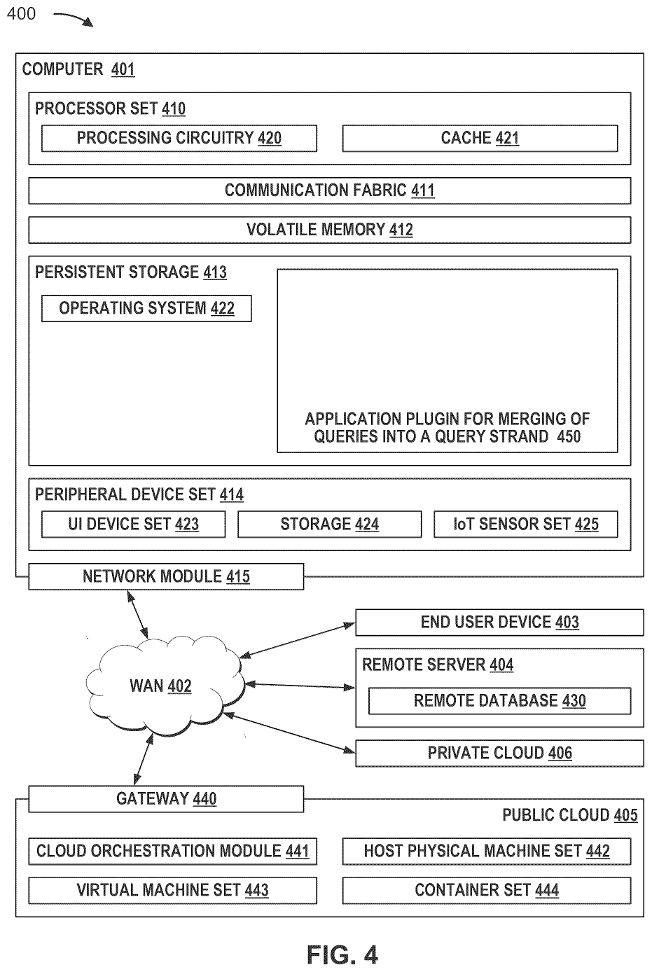

FIGS. 1A-1B show an example implementation 100 showing receiving and responding to queries of one or more query strands. As shown in FIG. 1A, a computing device may be configured to receive or process queries. The computing device may be configured to receive the queries via an input device that is local to the computing device or may be configured to receive the queries from another computing device (e.g., an input device, mobile phone, personal computer, among other examples) via a network connection (e.g., a direct connection or via one or more network devices). In some aspects, the computing device may include, or may be included in, the computer 401 of FIG. 4 or device 500 described below.

As shown in FIG. 1A, and by reference number 105, the computing device may receive a first query. In some aspects, the first query may include a text input, an audio input, or a structured query, among other examples. The computing device may convert the text input or audio input into a structured query before performing further operations.

As shown by reference number 110, the computing device may establish a first query strand. In some aspects, the computing device may establish the first query strand based at least in part on the first query not being associated with an existing query strand. For example, the first query may not be associated with a data set, an attribute, or a value of an existing query strand. In some aspects, a set of existing query strands may include query strands that have received a query within a threshold time from receipt of the first query. For example, query strands without an associated query within a configured amount of time before receipt of the first query may be considered inactive and the computing device may not assign new queries to those query strands. Instead, the computing device may establish the first query as a new query strand.

A query strand 115 may include one or more clauses having one or more parameters. For example, query strand 115 is shown having clause 1 with parameters of the first query and clause 2 with parameters of the first query. For example, the first query may define parameters (e.g., an operator and one or more values) for clause 1 and clause 2 that are established for the query strand 115.

As shown by reference number 120, the computing device may provide a response to the first query. For example, the computing device may provide the response to the user via a local output device, such as a display or a speaker, among other examples. In some aspects, the computing device may provide the response to the user via another computing device that is local to the user. For example, the computing device may provide the response to the other computing device via a network and network devices. In an example, the computing device may include, or be included in, an edge node of a network (e.g., a cellular network) that is configured to perform processing for a user device (e.g., a cellular phone) or operations for an application at an edge of the network to reduce latency.

As shown in FIG. 1B, and by reference number 125, the computing device may receive a second query. Similar to the first query, the second query may include a text input, an audio input, or a structured query, among other examples. The computing device may convert the text input or audio input into a structured query before performing further operations.

As shown by reference number 130, the computing device may determine whether the second query is associated with the first query strand. For example, the computing device may determine that the second query with the query strand 115 based at least in part on the second query including an explicit mention of a data set (e.g., associated with the query strand) or a synonym, the second query including an explicit mention of an attribute of the data set or a synonym, the second query including an explicit mention of a value of an attribute of the data set or a synonym, context (e.g., graphical context) obtained with the second query, or feedback from a user from a clarifying question from the computing device, among other examples.

As shown by reference number 135, the computing device may establish a second query strand or merge the second query with the first query strand (e.g., based at least in part on the determination described in connection with reference number 130). If merged with the first query strand, the second query may be described as a partial query and a result of the merge may be considered a new cumulative query.

In the case where the computing device establishes a second query strand, the computing device may establish a query strand 140 that includes one or more clauses having parameters of the second query. For example, the computing device may establish the query strand 140 with a clause 1 with parameters of the second query and a clause 2 with parameters of the second query.

In the case where the computing device merges the second query with the first query strand, the query strand 115 may be modified as shown. For example, the query strand 115 may include clause 1 with parameters of one or more of the first query or the second query. Clause 1 may include parameters of only the first query based at least in part on the second query not identifying parameters associated with clause 1. Clause 1 may include parameters of the first query and the second query based at least in part on the parameters of the second query being compatible with the parameters of the first query. Clause 1 may include parameters of only the second query based at least in part on the parameters of the second query being incompatible with the parameters of the first query. The query strand 115 may include clause 2 with parameters of one or more of the first query or the second query

As shown by reference number 145, the computing device may provide a response to the second query. For example, the computing device may provide a response to the query strand 115 based at least in part on merging the second query with the first query (e.g., a query strand associated with the first query), or a response to the query strand 140 based at least in part on establishing a new query strand for the second query.

As indicated above, FIGS. 1A-1B are provided as an example. Other examples may differ from what is described with regard to FIGS. 1A-1B. For example, additional query strands, additional queries, or different clauses or parameters may be used in the context of FIGS. 1A-1B.

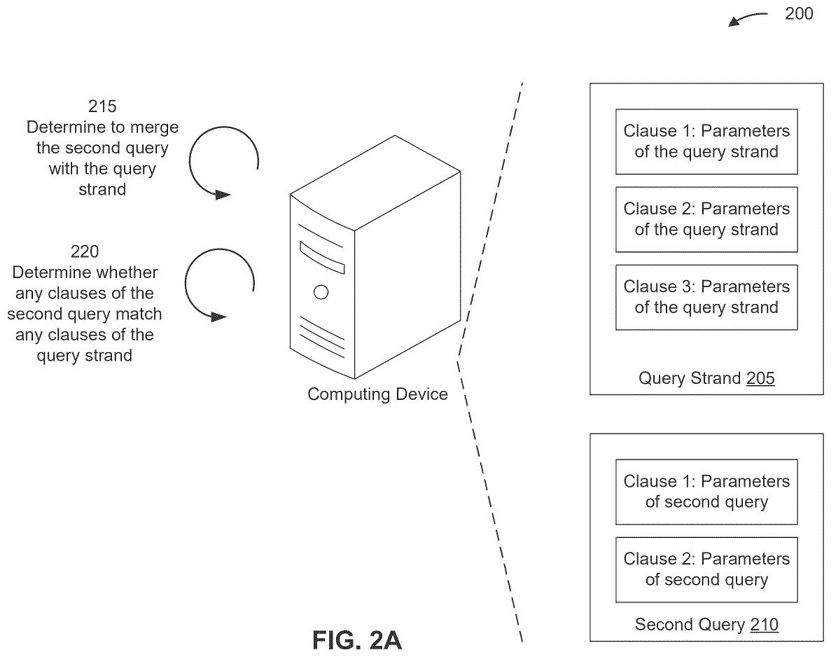

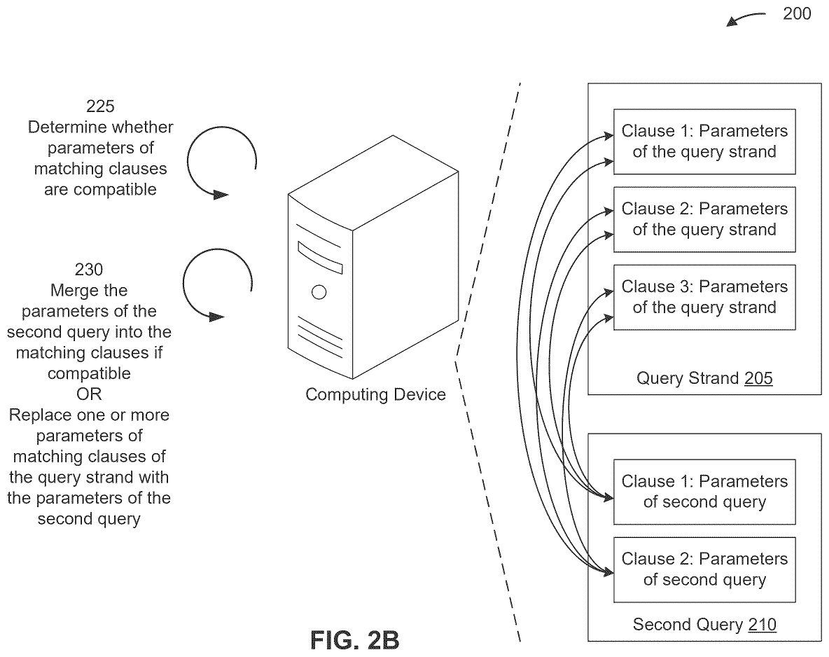

FIGS. 2A-2B show an example implementation 200 showing merging of queries into a query strand. As shown in FIG. 2A, a computing device may be configured to receive or process queries and merge related queries into a query strand. As in FIGS. 1A-1B, the computing device may be configured to receive the queries via an input device that is local to the computing device or may be configured to receive the queries from another computing device (e.g., an input device, mobile phone, personal computer, among other examples) via a network connection (e.g., a direct connection or via one or more network devices). In some aspects, the computing device may include, or may be included in, the computer 401 of FIG. 4 or device 500 described below.

As shown in FIG. 2A, a computing device may have a query strand 205 (e.g., an existing query strand) that includes clauses from one or more previously received queries, including a first query (e.g., the first query of FIG. 1A). The computing device may receive a second query 210 that includes parameters for one or more clauses.

As shown by reference number 215, the computing device may determine to merge the second query 210 with the query strand 205 (e.g., the query strand associated with the first query of FIG. 1A). For example, the computing device may determine to merge the second query 210 into the query strand 205 based at least in part on the query strand 205 and the second query 210 being associated with a same data set (e.g., table of information). In some aspects, the computing device may determine to merge the second query 210 with the query strand 205 based at least in part on the second query 210 including an explicit mention of a data set (e.g., associated with the query strand 205) or a synonym, the second query including an explicit mention of an attribute of the data set or a synonym, the second query 210 including an explicit mention of a value of an attribute of the data set or a synonym, context (e.g., graphical context) obtained with the second query 210, or feedback from a user from a clarifying question from the computing device, among other examples.

As shown by reference number 220, the computing device may determine whether any clauses of the second query 210 match any clauses of the query strand 205. For example, the computing device may determine whether the second query 210 includes an indication of parameters for an attribute that is already included in the query strand 205.

The computing device may organize the query strand 205 and the second query 210 into clauses. A clause may include a single attribute (e.g., unique to the clause), one or more operators, and one or more values for the operator. For example, a clause having an attribute of “State” may include an operator of “=” and one or more values for names of states (e.g., “Texas”). Similarly, a clause having an attribute of “number of beds” may include an operator of “<,” “>,” or “=” or a combination of operators and one or more values. For example, a “number of beds” may include “<100” and “>500” or may include “>100,” among other examples. Further examples of operators may include ≤, ≥, “neq” (not equal), “in” (matching any value in a value list), “all” (matching all values in a value list), or “nin” (matching nothing in a value list), among other examples.

As shown in FIG. 2B, and by reference number 225, the computing device may determine whether parameters of matching clauses are compatible. To evaluate whether parameters of matching clauses are compatible, the computing device may analyze an operator and associated value of a first clause with an operator and associated value of a second clause (of the second query that matches the first clause). A result of an evaluation of compatibility may indicate a degree of compatibility (e.g., {degree, resultOp, resultVal}).

A degree of the compatibility may have a value, such as conflict if the conditions Op1:V1 and Op2:V2 are incompatible (e.g. Beds<200 and Beds>500). The value may be compatible if both conditions can be satisfied simultaneously (e.g. Beds<200 and Beds>100). The value may be mergeable if Op2:V2 can be combined with Op1:V1 to produce a viable resultant resultOp: resultVal. In some aspects, the value of mergeable may have a configured level of leniency.

In some aspects, operators have compatible, conflicting, or mergeable relationships. For example, in a lenient configuration (e.g., merge when possible even if data of the response may be unusual), conflicts may exist when the first operator is “=” and the second operator is “=,” “>,” “≥,” “<,” “≤,” “neq,” “in,” “all,” or “nin,” and may be mergeable if the second operator is “in” (e.g., concatenate V1 and V2). Similarly, conflicts may exist when the second operator is “=” and the first operator is “=,” “>,” “≥,” “<,” “≤,” “neq,” “in,” “all,” or “nin,” and may be mergeable if the second operator is “in” (e.g., concatenate V1 and V2).

In the lenient configuration, conflicts may exist where the first operator is “>” or “≥” and the second operator is “>,” “≥,” “in,” “all,” or “nin” and may be compatible when the second operator is “<” or “≤” if V2<V1 (if Op2 is <) or V2≤V1 (if Op2 is ≤) (else, in conflict) or when the second operator is “neq” if V2>V1 (else, in conflict). Similarly, conflicts may exist when the second operator is “>” or “≥” and the first operator is “>,” “≥,” “all,” or “nin” or when the first operator is “in” and a max value of V1>V2 or a max value of V1≥V2 (else, mergeable to “in:V1>V2” or “in:V1≥V2,” according to Op2) and may be compatible when the first operator is “<” or “≤” if V1>V2 (else, in conflict) or when the second operator is “neq” if V1>V2 (else, in conflict).

In the lenient configuration, conflicts may exist where the first operator is “<” or “≤” and the second operator is “<” or “≤,” “in,” “all,” or “nin” and may be compatible when the second operator is “neq” if V2>V1 (else, in conflict). Similarly, conflicts may exist when the second operator is “<” or “≤” and the first operator is “<” or “≤” “all,” or “nin” or when the first operator is “neq” and V1>V2 or V1≥V2 (according to an opposite of Op2) (else compatible) or when the first operator is “in” and V2<V1 or V2≤V1 (according to Op2) (else mergeable to “in:V1<V2” or “in:V1≤V2,” according to Op2).

In the lenient configuration, conflicts may exist where the first operator is “neq” and the second operator is “in” or “all” and may be mergeable when the second operator is “neq” (mergeable to “nin:V1, V2”) or when the second operator is “nin” (mergeable to “nin: concatenation (V1, V2)”). Similarly, conflicts may exist when the second operator is “neq” and the first operator is “in” or “all” and may be mergeable when the first operator is “neq” (mergeable to “nin:V1, V2”) or when the first operator is “nin” (mergeable to “nin: concatenation (V1, V2)”).

In the lenient configuration, conflicts may exist where the first operator is “in” and the second operator is “all” or “nin” and may be mergeable when the second operator is “in” (mergeable to “in: concatenation (V1,V2)”). Similarly, conflicts may exist where the second operator is “in” and the first operator is “all” or “nin” and may be mergeable when the first operator is “in” (mergeable to “in: concatenation (V1,V2)”).

In the lenient configuration, conflicts may exist where the first operator is “all” and the second operator is “nin” and may be mergeable when the second operator is “all” (mergeable to “all: concatenation (V1,V2)”). Similarly, conflicts may exist where the second operator is “all” and the first operator is “nin” and may be mergeable when the first operator is “all” (mergeable to “all: concatenation (V1, V2)”).

In the lenient configuration, the first operator and the second operator may be mergeable when both are nin (mergeable to “nin: concatenation (V1,V2)”).

In some aspects, when a conflict exists, the computing device may replace the Op1:V1 with Op2:V2. In some aspects, a conflict may exist if the conditions Op1:V1 and Op2:V2 are incompatible. For example, where the existing query strand (Op1:V1) includes a parameter of “Beds<200” and the second query includes a parameter of “Beds>500.” In this case, the query strand may be modified to replace “Beds<200” with “Beds>500.” The parameters may be compatible if both conditions can be satisfied simultaneously. For example, the existing query strand may include a parameter of “Beds<200” and the second query may include a parameter of “Beds>100,” which may provide a range of “100<Beds<200” where both parameters are satisfied simultaneously. In some aspects, parameters may be mergeable if Op2:V2 can be combined with Op1:V1 to produce a viable resultant result “resultOp: resultVal.”

In an example of a moderate leniency for merging and conflicts, several changes may be made relative to the lenient configuration. For example, conflicts may exist when Op1 is “>,” “≥,” “<,” or “≤” and Op2 is “neq;” or when Op1 is “neq” or “in” and Op2 is ““>,” “≥,” “<,” or “≤.” In some aspects, the moderate leniency is associated with a moderate effort to merge Op2:V2 with Op1:V1.

In some aspects, a strict configuration (low leniency) for merging and conflicts, any matched clauses may result in a replacement of Op1:V1 with Op2:V2.

In some aspects, a level of leniency may be based at least in part on a default value, a selection by the user, derived from a user utterance, or based at least in part on interactions with the user.

In some aspects, the computing device may derive a merging mode (e.g., level of leniency) from a user utterance (e.g., language in a query or outside of a query). For example, the computing device may infer the merging mode from words included in the query (e.g., to maintain a default mode or vary from a default mode). In some examples, the computing device may have a default mode set as a moderate merging mode. The computing device may receive a first query of “Show me hospitals with at least 200 beds” and a second query of “Show me hospitals with less than 500 beds.” The result using a moderate merging mode is “Number of beds: 200≤beds<500.” If instead, the second query is “Only show me hospitals with less than 500 beds,” the computing device may infer a strict merging mode to override the default mode to generate a response to the second query with ““Number of beds: beds<500.”

In some aspects, the computing device may infer a merging mode via an explicit command to change the merging mode. For example, the computing device may receive a command of “Change the query merging mode to ‘Lenient’” or “Change the query mering mode to ‘Override.’”

As shown by reference number 230, the computing device may merge (e.g., combine or add) the parameters of the second query 210 to the matching clauses if compatible OR the computing device may replace one or more parameters of matching clauses of the query strand 205 with the parameters of the second query 210.

The following includes an example of a merging algorithm that may be performed by the computing device.

```
Q3= { }
For each clause (ATTRIBUTE) C2 in Q2:
  C1 = clause in Q1 with same attribute A2 as Q2
  If ((C1 does not exist) OR (C2 has more than one operator)
    C3 = C2
  Else
    For each operator O2 in C2
      For each operator O1 in C1
        compatibility = EvaluateCompatibility(O1, C1[O1], O2,
        C2[O2])
        If (compatibility.degree == ‘conflicting ’)
          C3[O2] = C2[O2] // C1 is replaced by C2
        Else if (compatibility.degree == ‘compatible ’)
          C3[O1] = C1[O1]
          C3[O2] = C2[O2] // C1 and C2 are both included in C3
        Else if (compatibility.degree == ‘mergeable ’)
          C3[compatibility.resultOperator] =
compatibility.resultValue
  Q3[A2] = C3 // Add clause C3 to the resultant cumulative query
```

In some aspects, the computing device may merge queries based at least in part on dependency of filters (e.g. parameters including operators and values). In some aspects, dependencies may include semantic dependencies or data model dependencies.

For a semantic dependency, a scope of the parameter may imply whether to add a parameter of the second query to the query strand, to merge the parameter of the second query to the query strand, or to replace the parameter of the query strand with the parameter of the second query. For example, mentioning a city or state (e.g., a narrower geographical area) may automatically fixate a parameter associated with a country. Having an explicit mention of a country in the second query may indicate a desire of the user to drop the state filter from the query strand (e.g., because the second query indicating the country is broader to the query strand indicating the city or state). However, indicating the city or state in the second query with the country in the query strand may indicate a desire to narrow the geographic area to the city or state. In a particular example, query strand may include a query structure based at least in part on a query of “show me hospitals in Paris” (e.g., city=Paris) and a second query may include “Show me hospitals in USA” (e.g., country=USA). In this case, city=Paris should be dropped from the query strand.

For an example of data model dependency, a query strand may include a parameter associated with “Show me the number of beds in Texas City Hospital” (e.g., name=“Texas City Hospital”) and a second query may include “Show me the number of beds in hospital id TX0014” (e.g., ID=TX0014). In this case, the parameters “name” and “ID” both relate to specific hospital identification, so only one should be used. Assuming “hospital ID” is a primary key and therefore has a 1:1 relationship with hospital name, an explicit mention of hospital ID in the second query should include dropping the filter associated with a hospital name.

In some aspects, the computing device may detect implicit dependencies between clauses (e.g., “columns” or “col”) based at least in part on meanings of words in the clauses. For example, “state” has a dependency on “Country” (e.g., a fixed state can have only one fixed country) can be inferred based at least in part on the meaning of “state” and “country” without analyzing values in these clauses (e.g., parameters). To develop an algorithm to find these implicit dependencies, the computing device may use an application (e.g., wordnet) and use features such as “holonym” and “Meronymy” to capture part-whole relations. For example, “city” has part-holonym with “state” and “state” has member-holonym with “Country.”

An example algorithm may include:

```
Func. detectIfDependent(colA, colB)
  Wordnet node wA= Search “colA ” in WordNet
  holonym_nodes_set = {transitive closure of *-holonym relations
from different meanings of wA ” }
(The above line will create a finite set because there is a guaranteed
closure at the root node of wordnet which is “entity”)
  If holonym_nodes_set of wA contains colB
    return true
  else
    return false;
detectIfDependent(“state”, “Country”) −> True
detectIfDependent(“city”, “Country”) −> True
detectlfDependent(“hospital”, “City”) −> False
```

In another example, the computing device may use a Large Language Model (LLM) to detect whether two columns have a dependent relationship. For example, the function detectIfDependent(colA, colB) may be implemented by submitting, to an LLM, a prompt that asks the LLM to output “True” if the colA is semantically dependent on colB and “False” otherwise.

In some aspects, the computing device may detect implicit dependencies between multiple fields in a datastore by analyzing the n-arity relationship shown by the values in those fields.

For two fields f1 and f2, if the n-arity can be defined as 1:1, then a unique value v1 from f1 is associated with a unique value v2 in f2. Explicitly mentioning f1=v1 in a query automatically entails filtering in f2=v2 as well. For example, hospital_ID->hospital_Name

If the n-arity can be defined as 1:n, a unique value v1 from f1 is associated with n different values in f2. Explicitly mentioning f1=v1 in a query does not automatically entail a single value filter for f2, although the vice versa is true (e.g., a unique value filter for f2 means a unique value filter for f1 as well. For example, state->City.

If the n-arity can be defined as m:1, there are m different values from f1 for a unique value in f2. Explicitly mentioning f1=v1 in a query automatically entails filtering in f2=v2 as well. Although the vice versa is not true (e.g., a unique value filter for f2 does not mean a unique value filter for f1 as well). For example, state->Country.

If the n-arity can be defined as m: n, there are m different values from f1 for a unique value in f2 and there are n different values from f2 for a unique value in f1. Explicitly mentioning f1=v1 in a query does not automatically entail a single value filter for f2 nor vice versa. For example, organization->Country.

The computing device may analyze the n-arity relationship between every pair of columns in a table or across table which can be joined.

In some aspects, the computing device may detect implicit dependencies among filters by querying the data set (e.g., table of information or data store). Not all dependencies can be captured by the semantic meaning of clause words. For example, HospitalID has a dependency with HospitalName (e.g., a fixed ID will have a fixed name), but that is not apparent from the clause names. Such dependencies may be inherent in the data organization and therefore, discoverable by data analysis. The computing device may query a table or datastore to detect the type of relationship between them (e.g., 1:1, 1:n, n:1, m:n). An example algorithm may include:

```
Query q1 =Select count distinct colA as Counts from T group by colB
  result1 = Execute q on T
Query q2 =Select count distinct colB as Counts from T group by colA
  result2 = Execute q on T
If max(result1.counts)==1 && max(result2.counts)==1
  return 1:1
If max(result1.counts)==1 && max(result2.counts)>1
  return 1:n
If max(result1.counts)>1 && max(result2.counts)==1
  return m:1
If max(result1.counts)>1 && max(result2.counts)>1
  return m:n
```

In some aspects, the computing device may evaluate a field compatibility using n-ary relations. For example, EvaluateFieldCompatibility(f1₁,f2) may produce a compatibility result of the form: {status, Action}. For example, if the relationship of the query strand to the second query is 1:1, Status: Conf; Action: drop the previous filter. If the relationship of the query strand to the second query is 1:m, Status: Conf; Action: drop the previous filter. If the relationship of the query strand to the second query is n:1, Status: Comp; Action: add the previous filter. If the relationship of the query strand to the second query is n:m, Status: Comp; Action: add the previous filter.

The following are some examples of merging clauses with a moderate or lenient merging configuration:

Q1 is Beds<200 and Q2 is Beds>100. The merged query strand is Q3: Beds>100 AND Beds<200 based at least in part on applying the rule “If (V1>V2) comp; Else conf” (e.g., since 200>100, the result is comp).

Q1 is Courses in [“AP English”, “AP Calculus”] and Q2 is Courses=“AP French.” The merged query strand is Courses in [“AP English”, “AP Calculus”, “AP French”] based at least in part on applying the rule “In: Concat (V1,V2).”

Q1 is Beds>100 AND Beds<500 and Q2 is Beds>300 AND Beds<400. The merged query strand is Beds>300 AND Beds<400 based at least in part on applying the rule of Q1a, Q2a->conf; Q1a, Q2b->comp (Q1a is compatible with Q2b, but not with Q2a, so it is eliminated), Q1b, Q2a->comp, and Q1b, Q2b->conf (Q1b is compatible with Q2a, but not with Q2b, so it is eliminated), so Q2 overrides Q1 for this clause.

In some aspects, the computing device may infer sorting from implications within the queries. In some aspects, operators such as in, the computing device may infer a desired sorting from the resultant filtering command. For example, the filtering command is {attribute: “courses”, operator: “in”, value: [“AP English”, “AP Calculus”, “AP French”]}. All records that match the filter may be returned from the database. For each record, the computing device may compute a match score between the terms appearing in the “courses” attribute of the record and those appearing in the value list in the filter command. For example, totalCommonTerms=the total number of terms shared by the record and the filter value list, totalUniqueTerms=the total number of unique terms appearing in either the record or the filter value list, and matchScore=totalCommonTerms/totalUniqueTerms. For example, if a record contains [“AP English”, “AP French”, “AP German”], totalCommonTerms are 2, totalUnique Terms are 4, and a Match score=0.5. The records may be sorted according to their match scores and returned as a response to the query.

In some aspects, the terms may be weighted according to occurrence frequency in some selected corpus (e.g., an entire language, or limited to the application domain) in a manner akin to term frequency-inverse document frequency (TF-IDF).

As indicated above, FIGS. 2A-2B are provided as an example. Other examples may differ from what is described with regard to FIGS. 2A-2B. For example, additional query strands, additional queries, or different clauses or parameters may be used in the context of FIGS. 1A-1B.

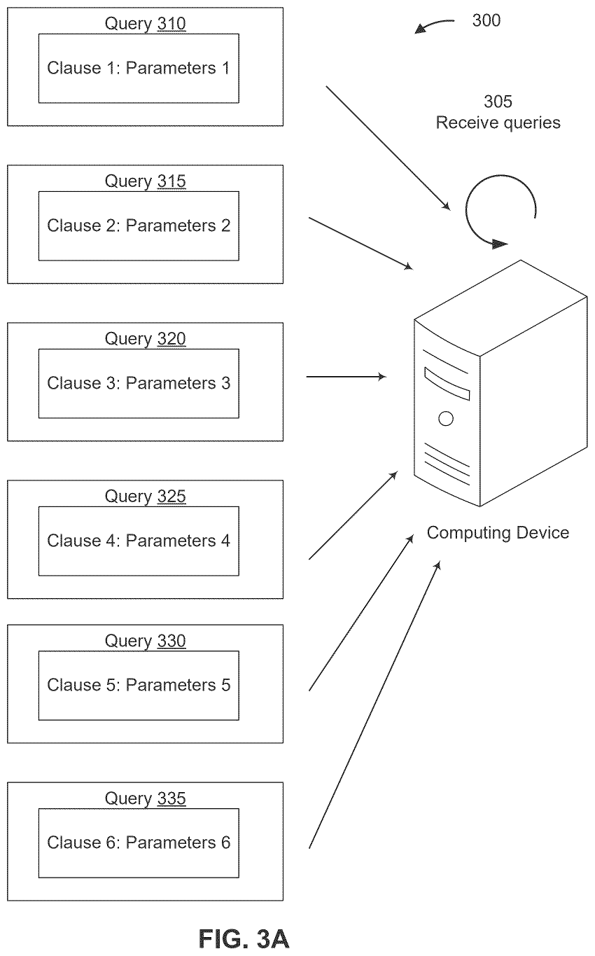

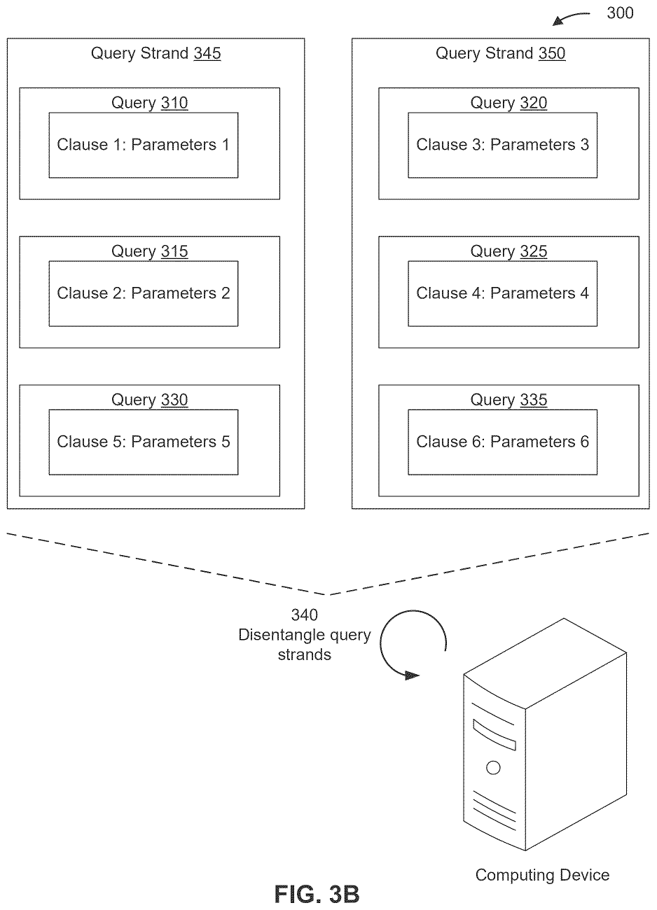

FIGS. 3A-3B are diagrams of an example implementation 300 described herein. As shown in FIGS. 3A-3B, example implementation 300 includes a computing device configured to receive queries. In some aspects, the computing device may be configured to receive queries via an input device local to the computing device (e.g., a microphone, a keyboard, or a touchscreen, among other devices). In some aspects, the computing device may receive the queries via an additional computing device or input device that is connected to the computing device via one or more network devices or infrastructure.

As shown in FIG. 3A, and by reference number 305, the computing device may receive a query 310 that includes parameters 1 for a first clause (clause 1), a query 315 that includes parameters 2 for a second clause (clause 2), a query 320 that includes parameters 3 for a third clause (clause 3), a query 325 that includes parameters 4 for a fourth clause (clause 4), a query 330 that includes parameters 5 for a fifth clause (clause 5), and a query 335 that includes parameters 6 for a sixth clause (clause 6). In other examples, the computing device may receive any number of queries and example 300 including six queries is not intended to be limiting in scope.

As shown in FIG. 3B, and by reference number 340, the computing device may disentangle query strands. For example, the computing device may establish a query strand 345 associated with query 310. The computing device may determine that query 315 is related to the query 310 and may be merged with the query strand 345. Upon receiving query 320, the computing device may determine that query 320 is not part of the query strand 345 and may establish a query strand 350. When the computing device receives queries 325, 330, and 335, the computing device may determine whether the queries are related to query strand 345, query strand 350, or neither of the existing query strands. The computing device my determine that query 330 is related to the query strand 345. The computing device may determine that query 325 and query 335 are related to the query strand 350. After determining related query strands of received queries, the computing device may merge a received query with the related query strand (e.g., as described herein).

In some aspects, the computing device may determine whether a new query is related to a query strand based at least in part on inferring a table to which the new query applies, and segregating queries accordingly. The computing device may assume that all queries belonging to the same table are part of the same query strand unless the computing device receives an explicitly indication that a query is to be regarded as the start of a new query strand.

In an example, a first query may include “Show me hospitals with between 200 and 500 beds.” A second query may include “Show me schools that offer courses in AP English or AP Calculus.” A third query may include “Show me hospitals with a helipad and less than 400 beds.” A fourth query may include “Show me those with at least 500 students.” A fifth query may include “Show me ones that offer AP French.” A sixth query may include “Show me those founded prior to 1980.” A seventh query may include “Show me ones in Texas. The seven queries are not all part of a single line of queries, but are instead related to multiple query strands with intermingled queries.

The computing device may attempt to disentangle a first query strand and a second query strand such that later-received queries refine (e.g., are merged with) queries of a same query strand. For example, the computing device may convert the queries from utterances (e.g., an unstructured format) to a structured query (e.g., with one or more clauses having operators and values). The computing device may then determine a data set (e.g., as a table of information) to which individual queries apply and segregate the queries accordingly. The computing device may assign all queries associated with an individual data set to a same query strand. In some aspects, the computing device may assign all queries associated with the individual data set to the same query strand unless an input (e.g., a user input) indicates that one or more queries associated with the individual data set are not to be merged into a query strand. As the computing device receives additional queries, the computing device may dynamically assign the additional queries to one of the existing query strands.

In some aspects, the computing device may determine associations of queries to individual data sets using one or more operations. For example, the computing device may identify within queries a mention (e.g., an explicit mention) of an individual data set or a synonym of the individual data set. For example, the computing device may use the mention of “hospitals” in the first and third queries to associate the first query and the third query with a data set of hospitals. Similarly, the computing device may use the mention of “schools” to associate the second query with a data set of schools.

The computing device may identify in a query a mention (e.g., an explicit mention) of an attribute (or synonym of the attribute) that can be linked (e.g., uniquely) to the individual data set. For example, the computing device may identify “students” within the fourth query as an attribute associated with “schools” to associate the fourth query with the data set of schools along with the second query.

The computing device may identify a mention (e.g., an explicit mention) of a value of an attribute or a synonym that can be linked (e.g., uniquely to an attribute of an individual data set. For example, the computing device may identify a mention of “AP French” within the fifth query as a value in an attribute list associated with “schools” to associate the fifth query with the schools data set along with the second query and the fourth query.

In some aspects, the computing device may use context (e.g., graphical context) to determine (e.g. via inference) the individual data set associated with the query. For example, the computing device may use context of an interaction with the computing device or other input device (e.g., a location of a cursor, a location of visual focus on a display, or an amount of time separating the query from a most-recent query or response from the computing device) to determine an existing query strand to which a new query belongs. Based at least in part on the sixth query and the seventh query having clauses and values (e.g., Year of Establishment<1980 and State=Texas) that may be applied to both of “Hospitals” and “Schools,” the computing device may determine associations with either the “Hospital” or “Schools” data set based at least in part on context, such as a location of a cursor, a focus of a user's eyes, or a gesture observed by the user. Additionally, or alternatively, the computing device may use context, such as a data set associated with a most recently presented response or an assignment of a most-recent query (e.g., assign query 6 and query 7 to “Schools” based at least in part on query 5 being assigned to “Schools”).

In some aspects, the computing device may request additional information from a user to indicate a preferred assignment of queries to a particular data set. For example, the computing device may present a prompt (e.g., audibly or visually) that asks the user whether the user intended to associate the query to one of the existing query strands or data sets (e.g., “Do you want to see hospitals founded prior to 1980 or schools founded prior to 1980,” or “Do you want to see hospitals in Texas or schools in Texas?”). In some aspects, the computing device may request the additional information based at least in part on a level of uncertainty of correct assignment to a query strand satisfying a threshold.

In some aspects, the computing device may perform an operation of assigning queries associated with a same data set to different query strands once the queries are segregated according to data sets. In some aspects, the user may be given an opportunity ability to express non-query commands, such as “reset the query for hospitals.” In this case, the utterance from the user pertains to queries but is not itself a query. Other non-query commands that can signify beginning a new strand may include, for example, “Only show me hospitals with helipads,” which may be interpreted to mean that a new query strand has started containing only the clause “Helipads=true.” In some aspects, the non-query command may include a less-precise command such as “start a new query.” In such a case, heuristics may be used to infer the data set (e.g., table of information) to which the user is referring. Such heuristics may include noting the data set for which a query was issued most recently, or the one for which cursor activity or other graphical representations indicate most recently. When such commands are detected, the next query for the given table may be interpreted as the beginning of a new query strand for that data set.

In some aspects, query strands pertaining to the same data set may be demarcated retrospectively after finding that interpreting a query as a follow-up partial query results in a cumulative query that retrieves no records. For example, if the fourth query indicates a request for schools with at least 500 students, the fifth query indicates a request for schools that offer AP French, but no school has at least 500 students and also offers AP French, the cumulative query would be an empty set. In this case, the computing device may provide a response that indicates all schools that offer AP French without consideration of a number of students. In some aspects, the computing device may provide an indication to the user that the query is being interpreted as a fresh query on the basis that it otherwise would yield no matching records. The computing device may provide an opportunity for the user to remove the last query (e.g., partial query) and try a different refining query.

Based at least in part on the computing device being configured to disentangle query strands based at least in part on contents of the query, context, or a request for information from the user, the computing device may provide responses to queries with improved accuracy and may reduce a quantity of additional queries to clarify an intent of the user, which may conserve computing resources.

As indicated above, FIGS. 3A-3B are provided as an example. Other examples may differ from what is described with regard to FIGS. 3A-3B.

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as application plugin for merging of queries into a query strand 450. In addition to application plugin for merging of queries into a query strand 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and application plugin for merging of queries into a query strand 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in application plugin for merging of queries into a query strand 450 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in application plugin for merging of queries into a query strand 450 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

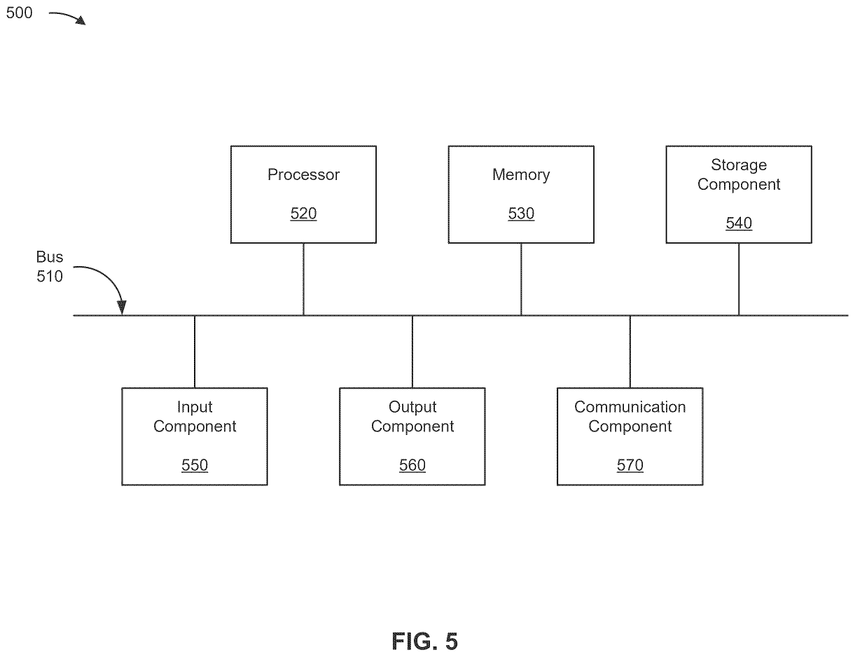

FIG. 5 is a diagram of example components of a device 500, which may correspond to the computing device 105, among other examples. In some implementations, the computing device 105 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may be a repository that stores a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

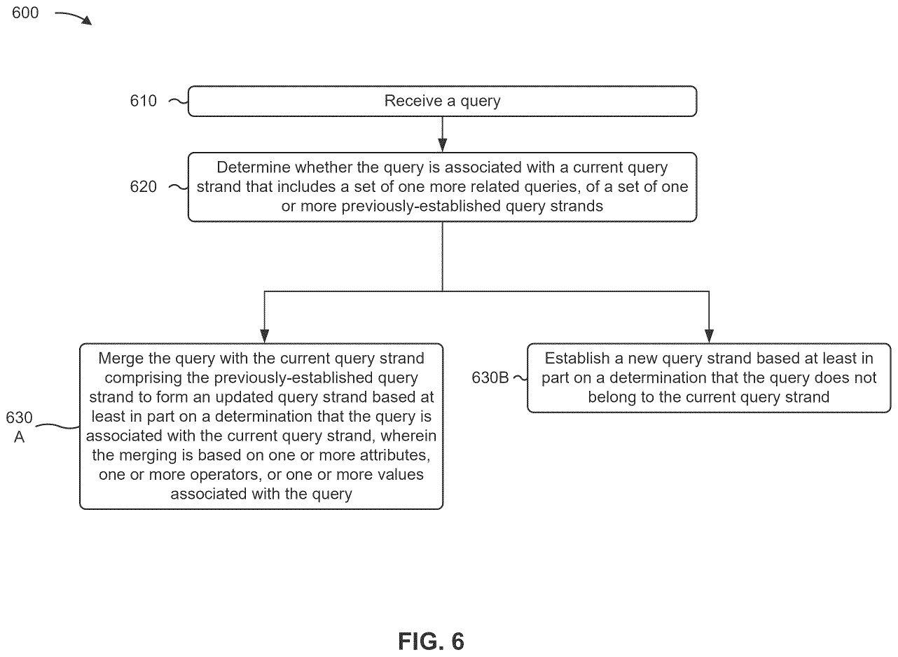

FIG. 6 is a flowchart of an example process 600 associated with merging of queries into a query strand brief description of the drawings. In some implementations, one or more process blocks of FIG. 6 may be performed by one or more computing devices (e.g., computing device of FIGS. 1A-3B, computer 401, or device 500). In some implementations, one or more process blocks of FIG. 6 may be performed by another device or a group of devices separate from or including the computing device, such as a network computing device, an application server, or a personal computing device. Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include receiving a query (block 610). For example, the computing device may receive a query, as described above.

As further shown in FIG. 6, process 600 may include determining whether the query is associated with a current query strand that includes a set of one more related queries, of a set of one or more previously-established query strands (block 620). For example, the computing device may determine whether the query is associated with a current query strand that includes a set of one more related queries, of a set of one or more previously-established query strands, as described above.

As further shown in FIG. 6, process 600 may include merging the query with the current query strand comprising the previously-established query strand to form an updated query strand based at least in part on a determination that the query is associated with the current query strand, wherein the merging is based on one or more attributes, one or more operators, or one or more values associated with the query; or establishing a new query strand based at least in part on a determination that the query does not belong to the current query strand (block 630A). For example, the computing device may merge the query with the current query strand comprising the previously-established query strand to form an updated query strand based at least in part on a determination that the query is associated with the current query strand, as described above. In some aspects, the merging is based on one or more attributes, one or more operators, or one or more values associated with the query.

As further shown in FIG. 6, process 600 may include (e.g., in the alternative to block 630A) establishing a new query strand based at least in part on a determination that the query does not belong to the current query strand (block 630B). For example, the computing device may establish a new query strand based at least in part on a determination that the query does not belong to the current query strand, as described above.

Process 600 may include additional implementations, such as any single implementation or any combination of implementations described below and/or in connection with one or more other processes described elsewhere herein.

In a first implementation, receiving the query comprises receiving the query within a natural language input, and converting the natural language input to a structured query.

In a second implementation, alone or in combination with the first implementation, the determination that the query is associated with the current query strand comprises one or more of identifying an indication of a same data set of the current query strand within the query, identifying an indication of an attribute associated with the same data set within the query, or identifying an indication of an attribute value associated with the same data set within the query.

In a third implementation, alone or in combination with one or more of the first and second implementations, identifying one or more of the indications of the same data set, identifying the indication of the attribute, or identifying the indication of the attribute value comprises one or more of identifying an explicit indication, or identifying a synonym of the data set, the attribute, or the attribute value.

In a fourth implementation, alone or in combination with one or more of the first through third implementations, the determination that the query is associated with the current query strand comprises one or more of obtaining contextual information associated with the query, or receiving clarifying information from a user.

In a fifth implementation, alone or in combination with one or more of the first through fourth implementations, obtaining contextual information associated with the query comprises one or more of obtaining a location of a cursor relative to a display of the data set associated with the current query strand or a different data set associated with a different previously-established query strand, or obtaining a location of a focus of the user relative to the display of the data set associated with the current query strand or the different data set associated with the different previously-established query strand.

In a sixth implementation, alone or in combination with one or more of the first through fifth implementations, the one or more related queries of the set of one or more related queries are associated with a same data set. In a seventh implementation, alone or in combination with one or more of the first through sixth implementations, merging the query with the current query strand comprises one or more of one or more clauses of the current query strand, adding one or more clauses of the query to the current query strand, or replacing one or more parameters of the current query strand with one or more parameters of the query.

In an eighth implementation, alone or in combination with one or more of the first through seventh implementations, the one or more clauses of the current query strand is based at least in part on the one or more parameters of the query being mergeable or compatible with the one or more clauses of the current query strand, wherein adding the one or more clauses of the query to the current query strand comprises adding the one or more clauses based at least in part on the current query strand not including a matching clause, wherein replacing the one or more parameters of the current query strand with one or more parameters of the query is based at least in part on the one or more parameters of the current query strand being in conflict with the one or more parameters of the query.

In a ninth implementation, alone or in combination with one or more of the first through eighth implementations, a determination of whether the one or more parameters of the query are mergeable, compatible, or in conflict with the one or more clauses of the current query strand is based at least in part on a merge mode.

In a tenth implementation, alone or in combination with one or more of the first through ninth implementations, process 600 includes removing one or more query classes, an indication that a subsequent or current query is to be interpreted as beginning a new query strand, or setting a merge mode.

In an eleventh implementation, alone or in combination with one or more of the first through tenth implementations, process 600 includes providing a response to the query. In a twelfth implementation, alone or in combination with one or more of the first through eleventh implementations, providing the response to the query comprises providing the response with sorted information, wherein the sorted information is sorted based at least in part on a match score associated with operators and values of clauses of the updated query strand with information elements of the sorted information.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

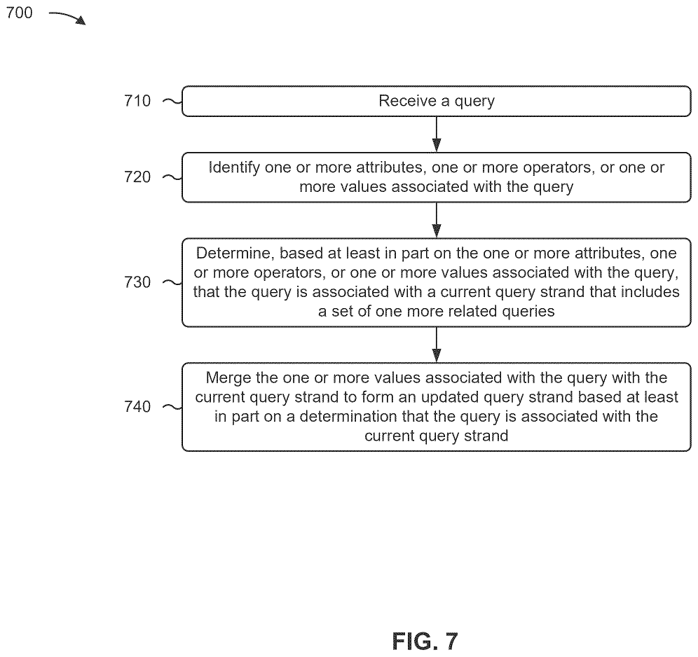

FIG. 7 is a flowchart of an example process 700 associated with merging of queries into a query strand brief description of the drawings. In some implementations, one or more process blocks of FIG. 7 may be performed by one or more computing devices (e.g., computing device of FIGS. 1A-3B, computer 401, or device 500). In some implementations, one or more process blocks of FIG. 7 may be performed by another device or a group of devices separate from or including the computing device, such as a network computing device, an application server, or a personal computing device. Additionally, or alternatively, one or more process blocks of FIG. 7 may be performed by one or more components of device 500, such as processor 520, memory 530, storage component 540, input component 550, output component 560, and/or communication component 570.

As shown in FIG. 7, process 700 may include receiving a query (block 710). For example, the computing device may receive a query, as described above. As further shown in FIG. 7, process 700 may include identifying one or more attributes, one or more operators, or one or more values associated with the query (block 720). For example, the computing device may identify one or more attributes, one or more operators, or one or more values associated with the query, as described above.

As further shown in FIG. 7, process 700 may include determining, based at least in part on the one or more attributes, one or more operators, or one or more values associated with the query, that the query is associated with a current query strand that includes a set of one more related queries (block 730). For example, the computing device may determine, based at least in part on the one or more attributes, one or more operators, or one or more values associated with the query, that the query is associated with a current query strand that includes a set of one more related queries, as described above.

As further shown in FIG. 7, process 700 may include merging the one or more values associated with the query with the current query strand to form an updated query strand based at least in part on a determination that the query is associated with the current query strand (block 740). For example, the computing device may merge the one or more values associated with the query with the current query strand to form an updated query strand based at least in part on a determination that the query is associated with the current query strand, as described above.

Process 700 may include additional implementations, such as any single implementation or any combination of implementations described below and/or in connection with one or more other processes described elsewhere herein.

In a first implementation, determining that the query is associated with the current query strand comprises identifying an indication of a same data set of the current query strand within the query, identifying an indication of an attribute associated with the same data set within the query, or identifying an indication of an attribute value associated with the same data set within the query.

In a second implementation, alone or in combination with the first implementation, identifying one or more of the indications of the same data set, the indication of the attribute, or the indication of the attribute value comprises identifying an explicit indication, or identifying a synonym of the data set, the attribute, or the attribute value. In a third implementation, alone or in combination with one or more of the first and second implementations, determining that the query is associated with the current query strand comprises obtaining contextual information associated with the query, or receiving clarifying information from a user.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

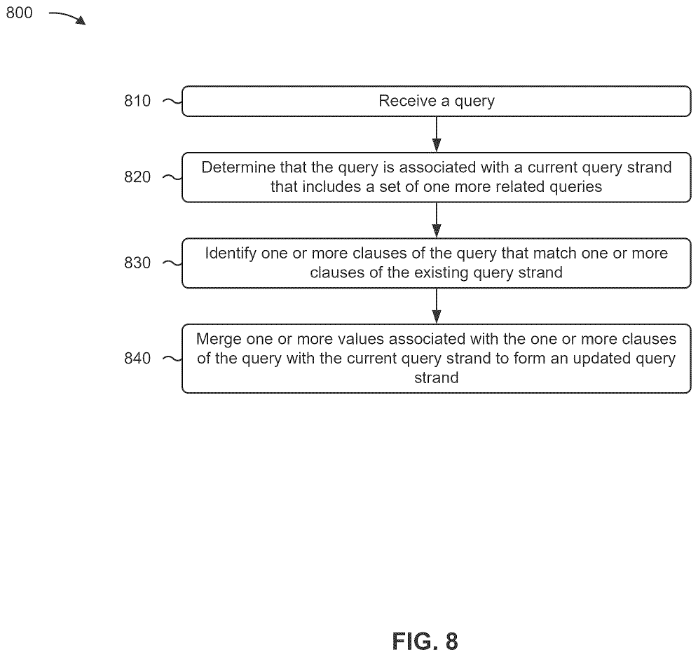

FIG. 8 is a flowchart of an example process 800 associated with merging of queries into a query strand brief description of the drawings. In some implementations, one or more process blocks of FIG. 8 may be performed by one or more computing devices (e.g., computing device of FIGS. 1A-3B, computer 401, or device 500). In some implementations, one or more process blocks of FIG. 8 may be performed by another device or a group of devices separate from or including the computing device, such as a network computing device, an application server, or a personal computing device. Additionally, or alternatively, one or more process blocks of FIG. 8 may be performed by one or more components of device 500, such as processor 520, memory 530, storage component 540, input component 550, output component 560, and/or communication component 570.

As shown in FIG. 8, process 800 may include receiving a query (block 810). For example, the computing device may receive a query, as described above. As further shown in FIG. 8, process 800 may include determining that the query is associated with a current query strand that includes a set of one more related queries (block 820). For example, the computing device may determine that the query is associated with a current query strand that includes a set of one more related queries, as described above.

As further shown in FIG. 8, process 800 may include identifying one or more clauses of the query that match one or more clauses of the existing query strand (block 830). For example, the computing device may identify one or more clauses of the query that match one or more clauses of the existing query strand, as described above.

As further shown in FIG. 8, process 800 may include merging one or more values associated with the one or more clauses of the query with the current query strand to form an updated query strand (block 840). For example, the computing device may merge one or more values associated with the one or more clauses of the query with the current query strand to form an updated query strand, as described above.

Process 800 may include additional implementations, such as any single implementation or any combination of implementations described below and/or in connection with one or more other processes described elsewhere herein.

In a first implementation, merging the one or more values comprises maintaining at least one value of the one or more clauses of the existing query strand that matches the one or more clauses of the query. In a second implementation, alone or in combination with the first implementation, merging the query with the current query strand comprises one or more of one or more clauses of the current query strand, adding one or more clauses of the query to the current query strand, or replacing one or more parameters of the current query strand with one or more parameters of the query.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

In addition to the implementations described above, elements described in connection with any of processes 600, 700, or 800 may be combined with elements of another of processes 600, 700, or 800.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a query;
determining whether the query is associated with a current query strand that includes a set of one more related queries, of a set of one or more previously-established query strands; and
selectively:
merging the query with the current query strand comprising the previously-established query strand to form an updated query strand based at least in part on a determination that the query is associated with the current query strand, wherein the merging is based on one or more attributes, one or more operators, or one or more values associated with the query; or
establishing a new query strand based at least in part on a determination that the query does not belong to the current query strand.

2. The method of claim 1, wherein receiving the query comprises:
receiving the query within a natural language input; and
converting the natural language input to a structured query.

3. The method of claim 1, wherein the determination that the query is associated with the current query strand comprises one or more of:
identifying an indication of a same data set of the current query strand within the query;
identifying an indication of an attribute associated with the same data set within the query; or
identifying an indication of an attribute value associated with the same data set within the query.

4. The method of claim 3, wherein identifying one or more of the indications of the same data set, identifying the indication of the attribute, or identifying the indication of the attribute value comprises one or more of:
identifying an explicit indication, or
identifying a synonym of the data set, the attribute, or the attribute value.

5. The method of claim 1, wherein the determination that the query is associated with the current query strand comprises one or more of:
obtaining contextual information associated with the query; or
receiving clarifying information from a user.

6. The method of claim 5, wherein obtaining contextual information associated with the query comprises one or more of:
obtaining a location of a cursor relative to a display of the data set associated with the current query strand or a different data set associated with a different previously-established query strand; or
obtaining a location of a focus of the user relative to the display of the data set associated with the current query strand or the different data set associated with the different previously-established query strand.

7. The method of claim 1, wherein the one or more related queries of the set of one or more related queries are associated with a same data set.

8. The method of claim 1, wherein merging the query with the current query strand comprises one or more of:
refining one or more clauses of the current query strand,
adding one or more clauses of the query to the current query strand, or
replacing one or more parameters of the current query strand with one or more parameters of the query.

9. The method of claim 8, wherein refining the one or more clauses of the current query strand is based at least in part on the one or more parameters of the query being mergeable or compatible with the one or more clauses of the current query strand,
wherein adding the one or more clauses of the query to the current query strand comprises adding the one or more clauses based at least in part on the current query strand not including a matching clause,
wherein replacing the one or more parameters of the current query strand with one or more parameters of the query is based at least in part on the one or more parameters of the current query strand being in conflict with the one or more parameters of the query.

10. The method of claim 9, wherein a determination of whether the one or more parameters of the query are mergeable, compatible, or in conflict with the one or more clauses of the current query strand is based at least in part on a merge mode.

11. The method of claim 1, comprising receiving a non-query command associated with one or more of:
removing one or more query classes,
an indication that a subsequent or current query is to be interpreted as beginning a new query strand, or
setting a merge mode.

12. The method of claim 1, comprising:
providing a response to the query.

13. The method of claim 12, wherein providing the response to the query comprises:
providing the response with sorted information, wherein the sorted information is sorted based at least in part on a match score associated with operators and values of clauses of the updated query strand with information elements of the sorted information.

14. A computer program product comprising:
one or more computer readable storage media, and program instructions collectively stored on the one or more computer readable storage media, the program instructions comprising:
program instructions to receive a query;
program instructions to identify one or more attributes, one or more operators, or one or more values associated with the query;
program instructions to determine, based at least in part on the one or more attributes, one or more operators, or one or more values associated with the query, that the query is associated with a current query strand that includes a set of one more related queries; and
program instructions to merge the one or more values associated with the query with the current query strand to form an updated query strand based at least in part on a determination that the query is associated with the current query strand.

15. The computer program product of claim 14, wherein to determine that the query is associated with the current query strand, the one or more program instructions comprise program instructions to:
identify an indication of a same data set of the current query strand within the query;
identify an indication of an attribute associated with the same data set within the query; or
identify an indication of an attribute value associated with the same data set within the query.

16. The computer program product of claim 15, wherein, to identify one or more of the indications of the same data set, the indication of the attribute, or the indication of the attribute value, the program instructions comprise program instructions to:
identify an explicit indication, or
identify a synonym of the data set, the attribute, or the attribute value.

17. The computer program product of claim 14, wherein, to determine that the query is associated with the current query strand, the program instructions comprise program instructions to:
obtain contextual information associated with the query; or
receive clarifying information from a user.

18. A system comprising:
one or more devices configured to:
receive a query;
determine that the query is associated with a current query strand that includes a set of one more related queries;
identify one or more clauses of the query that match one or more clauses of the existing query strand; and
merge one or more values associated with the one or more clauses of the query with the current query strand to form an updated query strand.

19. The system of claim 18, wherein merging the one or more values comprises:
maintaining at least one value of the one or more clauses of the existing query strand that matches the one or more clauses of the query.

20. The system of claim 18, wherein merging the query with the current query strand comprises one or more of:
refining one or more clauses of the current query strand,
adding one or more clauses of the query to the current query strand, or
replacing one or more parameters of the current query strand with one or more parameters of the query.
